(19) United States
(12) Patent Application Publication
(10) Pub. No.: US 2019/0190908 A1
(43) Pub. Date: Jun. 20, 2019

(54) SYSTEMS AND METHODS FOR AUTOMATIC MEETING MANAGEMENT USING IDENTITY DATABASE

(71) Applicant: Melo Inc., San Jose, CA (US)

(72) Inventors: Guobin SHEN, Beijing (CN); Zheng HAN, Beijing (CN)

(73) Assignee: Melo Inc., San Jose, CA (US)

(21) Appl. No.: 15/990,647

(22) Filed: May 27, 2018

Related U.S. Application Data
(60) Provisional application No. 62/607,534, filed on Dec. 19, 2017.

(51) Int. Cl. H04L 29/06; G06F 17/30; H04N 7/14; G06K 9/00; H04N 7/15

(52) U.S. Cl. CPC H04L 63/0861; G06F 17/30876; H04N 7/155; G06K 9/00892; H04N 7/147

(57) ABSTRACT

Embodiments of the disclosure provide a system for managing an access control a meeting. The system may include a communication interface that receives video and audio of the meeting. The system may also include a processor that executes instructions to generate a biometric characteristic for an attendee based on at least one of the video and the audio, and to associate identity information of the attendee with the biometric characteristic based on a comparison of the biometric characteristic with stored biometric characteristics of known users. The processor may also execute the instructions to generate a data stream that includes at least one of the video and the audio of the attendee, to tag the data stream with the identity information based on the associated biometric characteristic, and to selectively cause the data stream to be shown on a display based on selection of the tag.

### CROSS REFERENCE TO RELATED APPLICATION

The present application is based on and claims the benefits of priority to U.S. Provisional Application No. 62/607,534, filed Dec. 19, 2017, which is incorporated herein by reference in its entirety.

### TECHNICAL FIELD

The present disclosure relates to systems and methods for automatically controlling access to meeting logs, and more particularly, to systems and methods for automatically enrolling meeting participants in one or more identification databases, recording and tracking participant actions and meeting notes within meeting logs, and controlling access to the meeting logs using the identification database(s).

### BACKGROUND

Meetings can be held between multiple individuals or groups for a variety of personal, business, and entertainment-related reasons. The meetings can be held in-person or remotely (e.g., via conference and/or video calls), and scheduled ahead of time or initiated impromptu. Regardless of the type of meeting, attendance of the meeting is often tracked for purposes of post-meeting note dissemination.

Some meetings may be confidential in nature. For example, only invited attendees may be allowed to participate in the meeting. In addition, individuals with a sufficient security clearance may be able to attend the meeting, even if not invited.

Meeting is recorded and/or notes are often taken for later review by meeting attendees, as well as others who did not attend the meeting. When the meeting is confidential, limitations may be set in place regarding who can access the notes and/or meeting records. For example, only invitees, only attendees, and/or only individuals with an approved security clearance may be allowed access to the notes.

Historically, meeting and/or note access authorization has been a manual process performed by a meeting organizer and/or a security manager. This can be a tedious and inefficient process that is prone to error.

Embodiments of the disclosure address the above problems by systems and methods for automatically enrolling meeting participants in identification databases, logging meetings, and controlling meeting log access using identification databases.

### SUMMARY

Embodiments of the disclosure provide a system for managing an access control of a meeting. The system may include a communication interface configured to receive video of the meeting captured by at least one camera device and audio of the meeting captured by at least one microphone device. The system may also include a memory having computer-executable instructions stored thereon, and a processor in communication with the communication interface and the memory. The processor may be configured to execute the computer-executable instructions to generate a biometric characteristic for an attendee of the meeting based on at least one of the video and the audio, and to associate identity information of the attendee with the biometric characteristic based on a comparison of the biometric characteristic with stored biometric characteristics of known users. The processor may also be configured to execute the computer-executable instructions to generate a data stream that includes at least one of the video and the audio of the attendee, to tag the data stream with the identity information of the attendee based on the associated biometric characteristic, and to selectively cause the data stream to be shown on a display based on selection of the tag.

Embodiments of the disclosure further disclose a method for managing an access control of a meeting. The method may include receiving, by a communication interface, at least one of video of the meeting captured by at least one camera device and audio of the meeting captured by at least one microphone device, and generating, by a processor, a biometric characteristic for an attendee of the meeting based on at least one of the video and the audio. The method may also include associating, by the processor, identity information of the attendee with the biometric characteristic based on a comparison of the biometric characteristic with stored biometric characteristics of known users. The method may further include generating, by the processor, a data stream that includes at least one of the video and the audio of the attendee, and tagging, by the processor, the data stream with the identity information of the attendee based on the associated biometric characteristic. The method may additionally include selectively causing, by the processor, the data stream to be shown on a display based on selection of the tagging.

Embodiments of the disclosure further disclose a non-transitory computer-readable medium storing instructions that are executable by at least one processor to cause performance of a method for managing an access control of a meeting. The method may include receiving at least one of video of the meeting captured by at least one camera device and audio of the meeting captured by at least one microphone device, and generating a biometric characteristic for an attendee of the meeting based on at least one of the video and the audio. The method may also include associating identity information of the attendee with the biometric characteristic based on a comparison of the biometric characteristic with stored biometric characteristics of known users. The method may further include generating a data stream that includes at least one of the video and the audio of the attendee, and tagging the data stream with the identity information of the attendee based on the associated biometric characteristic. The method may additionally include selectively causing the data stream to be shown on a display based on selection of the tagging.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a schematic diagram of an exemplary meeting management system, according to embodiments of the disclosure.

FIG. 2 is a block diagram of an exemplary server that may be used in conjunction with the meeting management system of FIG. 1.

FIG. 3 illustrates an exemplary work flow for constructing a user identity database with bio info entries according to the present disclosure.

FIG. 4 illustrates two exemplary configurations of the meeting management system of FIG. 1.

FIGS. 5 and 6 are flowcharts of exemplary processes for managing meeting data, in accordance with embodiments of the present disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

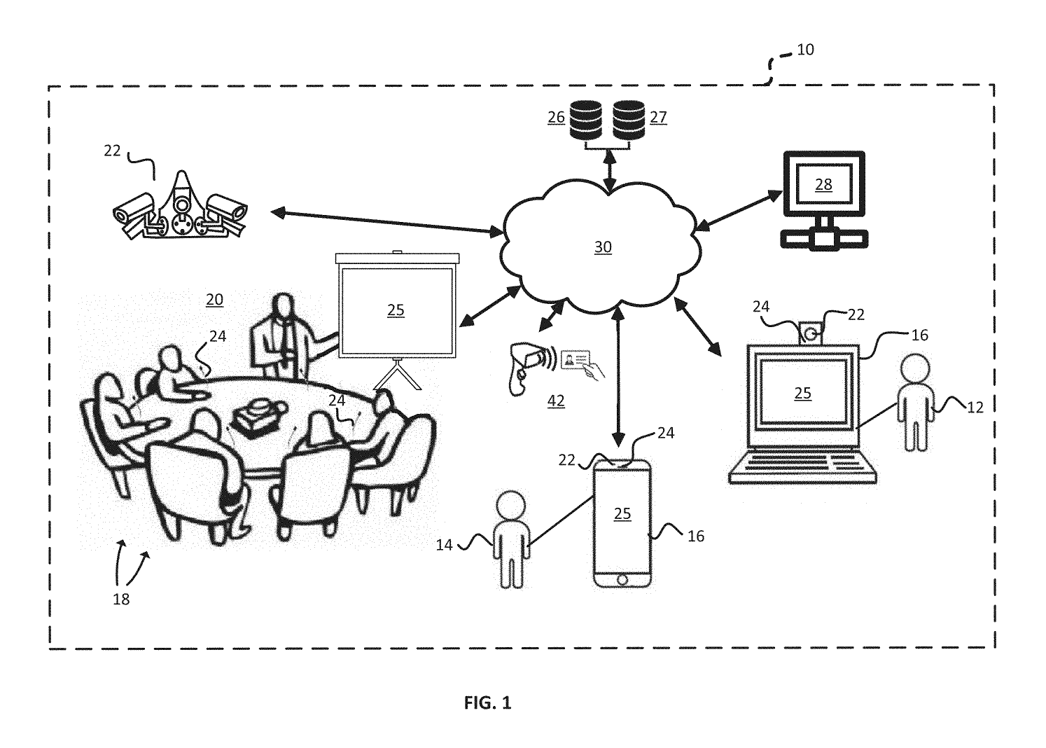

FIG. 1 illustrates an exemplary meeting management system (“system”) 10, in which various implementations described herein may be practiced. System 10 may be used, for example, in association with a meeting environment in which remote attendees (e.g., a first attendee 12 and a second attendee 14 attending via one or more portals 16) and/or local attendees (e.g., a group of attendees 18 co-located within a conference room 20) meet together to discuss topics of mutual interest. System 10 may include equipment that facilitates engagement in face-to-face conversations, visual (e.g., flipboard, chalkboard, whiteboard, etc.) displays, electronic (e.g., smartboard, projector, etc.) presentations, and/or real-time audio and video capture and sharing. This equipment may include, among other things, one or more camera devices 22, one or more microphone devices 24, one or more displays 25, at least one database (e.g., a user identity database 26 and/or a meeting log database 27), and a server 28 that communicates with the other components of system 10 by way of a network 30 and/or peer-to-peer connections.

Portal 16 may be a collection of one or more electronic devices having data capturing, data transmitting, data processing, and/or data displaying capabilities. In some embodiments, portal 16 includes a mobile computing device, such as a smart phone, a tablet, or a laptop computer. In other embodiments, portal 16 includes a stationary device such as a desktop computer or a conferencing console (e.g., a console located within conference room 20 and/or a meeting log frontend located within a review office—not shown).

In some embodiments, portal 16 includes input/output devices (I/O devices) that facilitate the capturing, sending, receiving and consuming of meeting and user information. The I/O devices may include, for example, a microphone, a camera, a keyboard, buttons, switches, a touchscreen panel, and/or a speaker. The I/O devices may also include one or more communication interfaces for sending information to and receiving information from other components of system 10 via network 30. In some embodiments, the communication interfaces can include an integrated services digital network (ISDN) card, a cable modem, a satellite modem, or another type of modem used to provide a data communication connection. As another example, the communication interfaces can include a local area network (LAN) card to provide a data communication connection to a compatible LAN. Wireless links can also be implemented by portal 16. In such an implementation, portal 16 can send and receive (e.g., via network 30) electrical, electromagnetic, and/or optical signals that carry digital data streams representing various types of information.

Each camera device 22 may be a standalone device communicatively coupled (e.g., via wires or wirelessly) to the other components of system 10, or a device that is integral with (e.g., embedded within) portal 16. Camera device 22 can include, among other things, one or more processors, one or more sensors, a memory, and a transceiver. It is contemplated that camera device 22 can include additional or fewer components. Each sensor may be, for example, a semiconductor charge-coupled device (CCD), a complementary metal-oxide-semiconductor (CMOS) device, or another device capable of capturing optical images and converting the images to digital still image and/or video data.

Camera device 22 may be configured to generate one or more video streams related to the meeting. For example, camera device 22 can be configured to capture images of the meeting attendees, as well as their actions and reactions during the meeting. Camera device 22 may also be configured to capture content presented or otherwise displayed during the meeting, such as writing and drawings on a whiteboard or paper flipper, and content projected onto display 25 (e.g., onto a projector screen in conference room 20).

Consistent with the present disclosure, at least one camera device 22 includes a sensor array having a wide (e.g., up to 360-degree) Field of View (FoV) and being configured to capture a set of images or videos with overlapping views. These images or videos may or may not be stitched together to form panoramic images or videos. For a local meeting (e.g., a meeting held within conference room 20), a wide FoV camera device 22 can record the entire conference room, including all of the local attendees and all the content displayed during the entire meeting. Capturing all the attendees and their actions may enable system 10 (e.g., server 28) to identify an active attendee (e.g., one who is talking and/or presenting) at any time, or to track a particular attendee (e.g., the CEO of the associated company) throughout the meeting. In some embodiments, camera device 22 associated with portal 16 includes a single sensor (e.g., a narrow FoV sensor), as each portal 16 is typically used by a single user.

Each microphone device 24 may be a standalone device communicatively coupled (e.g., via wires or wirelessly) to the other components of system 10, or an integral device that is embedded within an associated portal 16. In some embodiments, microphone device 24 can include various components, such as one or more processors, one or more sensors, a memory, and a transceiver. It is contemplated that microphone device 24 can include additional or fewer components. The sensor(s) may embody one or more transducers configured to convert acoustic waves that are proximate to microphone device 24 to a stream of digital audio data. In some embodiments, microphone device 24 transmits a microphone feed to system 10 (e.g., to server 28), including audio data. Consistent with the present disclosure, at least one microphone device 24 may include a sensor array (i.e., a mic-array). The use of a mic-array to capture meeting sound can help record attendees' speeches more clearly, which may improve the accuracy of later automatic speech recognition processes. The mic-array can also help to differentiate among different speakers' voices, when attendees are speaking at the same time.

Camera devices 22 and microphone devices 24 can be configured to packetize and transmit video and audio feeds, respectively, to server 28 and/or database 26, 27 via network 30. Data may be transmitted in real-time (e.g., using streaming) or intermittently (e.g., after a set time interval). In some embodiments, network 30 includes, alone or in any suitable combination, a telephone-based network (such as a PBX or POTS), a local area network (LAN), a wide area network (WAN), a dedicated intranet, and/or the Internet. Further, architecture of network 30 may include any suitable combination of wired and/or wireless components. For example, the architecture may include non-proprietary links and protocols, or proprietary links and protocols based on known industry standards, such as J1939, RS-232, RP122, RS-422, RS-485, MODBUS, CAN, SAEJ1587, Bluetooth, the Internet, an intranet, 802.11 (b, g, n, ac, or ad), or any other communication links and/or protocols known in the art.

Each display 25 may include a liquid crystal display (LCD), a light emitting diode (LED) screen, an organic light emitting diode (OLED) screen, a projector screen, a whiteboard, and/or another known display device. Display 25 may be used to display video signals, graphics, text, writing, audio signals, etc. to a local and/or remote meeting attendee and/or to a meeting reviewer.

Databases 26 and/or 27 may include a volatile or non-volatile, magnetic, semiconductor, tape, optical, removable, non-removable, or other type of storage device or tangible computer-readable medium. Databases 26 and/or 27 may store information relating to particular users (e.g., attendees and/or non-attending users) of system 10 and/or information relating to data streams captured during previously conducted and/or ongoing meetings. The information stored within databases 26 and/or 27 may come from any source and be provided at any time and frequency. For example, the information could be continuously streamed from system components (e.g., from camera device(s) 22 and/or microphone devices 24) during a meeting, downloaded from system components at conclusion of a meeting, manually entered (e.g., via portals 16) based on live observations during and/or after a meeting, automatically retrieved from an external server, intermittently pulled from “the cloud,” or obtained in any other manner at any other time and frequency. In addition to the user and/or meeting information, database 26 and/or database 27 may also include tools for analyzing the information stored therein. Server 28 may access database 26 and/or database 27 to determine relationships and/or trends relating to particular users of system 10 and/or meetings, and other such pieces of information. Server 28 may pull information from database 26 and/or database 27, manipulate the information, and analyze the information. Server 28 may also update the information, store new information, and store analysis results within database 26 and/or database 27, as desired.

Database 26 may be a data storage device that stores information associated with meeting attendees and/or other users of system 10. In some embodiments, database 26 may be a local database or a cloud database. The attendee and/or user information may include identification information (e.g., ID names and/or numbers), contact information (e.g., phone numbers and/or email addresses), calendar information (e.g., meeting schedules or meeting invitations), and biometric characteristics (e.g., body characteristics, facial characteristics, voice characteristics, retinal characteristics, fingerprint characteristics, etc.) that are unique to the attendee or user. Consistent with the present disclosure, server 28 may retrieve the attendee and/or user information from database 26, and use the information to aid in performance of the disclosed methods. For example, the information may be used to identify a meeting attendee and/or authorized user, to tag stored data streams inside meeting logs with attendee identification information, and to selectively allow access to the meeting logs based on the identification.

Database 27 may be a data storage device that stores information captured in association with particular meetings. In some embodiments, database 27 may be a local database or a cloud database. The meeting information may include any number of different data streams, for example a display position stream (DPS) including video of any displays 25 used during the meeting, one or more attendee position streams (APS) including video of attendees of the meeting, one or more voice streams (VS) including audio of the attendees, one or more caption streams (CS) associated with the voice stream(s), an index of key words used during the meeting, a list of topics discussed during the meeting, and/or an amendment stream (AS) associated with comments and/or reactions made after the meeting during review of the meeting by an authorized user. In some embodiments, some or all of these data streams may be compressed and stored together within database 27 as a single data file (e.g., a .mas file) associated with each particular meeting. As will be described in more detail below, server 28 and/or portals 16 may selectively access database 27 (e.g., via network 30) and retrieve these files for playback to identified and authorized users.

Server 28 can be a local physical server, a cloud server, a virtual server, a distributed server, or any other suitable computing device. Server 28 may be configured to process the multiple data streams acquired by meeting equipment (e.g., by camera device 22, microphone device 22, portals 16, etc.) during a meeting, and responsively generate a log of the meeting that includes the data streams and/or information derived from the data streams. In some embodiments, server 28 is further configured to share, distribute, and update the meeting log after the meeting. For example, server 28 may share the meeting log with authorized users via displays 25, allowing the users to access and provide feedback (e.g., via portals 16) associated with the data streams. Server 28 may then update the meeting log to include the user input.

In some embodiments, server 28 may be configured to share the meeting log with only select users. For example, only attendees of the meeting and/or particular users that have an appropriate security authorization may be granted access to the meeting log. As will be explained in more detail below, server 28 may determine which users attended the meeting and/or have the appropriate security authorization based on identification of the user. The user may be identified in many ways. For example, the user may be identified based on a calendar invite, based on a user's schedule, based on recognized images of the user that are captured by camera device 22, based a recognized voice of the user that is captured by microphone device 24, etc. In some embodiments, a dedicated security device 42 may facilitate this identification. Security device 42 may be, for example, a scanner (e.g., an ID badge scanner, a retinal scanner, a fingerprint scanner, a voice scanner, etc.) that is located at an entrance to or inside of conference room 20 or associated with portal 16. Security device 42 may generate identification signals that are directed to server 28 (e.g., via network 30) for further processing.

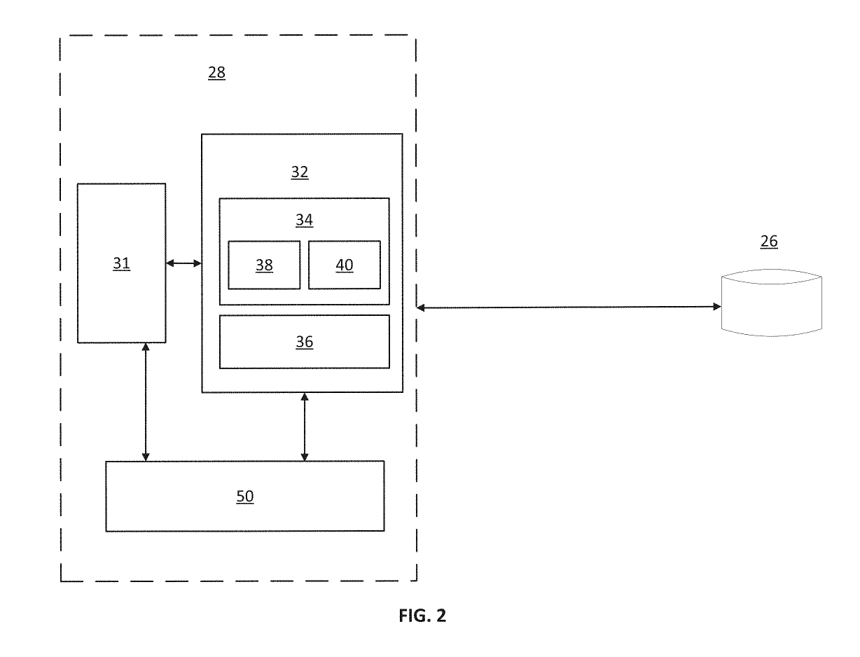

FIG. 2 is a block diagram of an exemplary server 28 that may be used in conjunction with the meeting logging and reviewing system of FIG. 1. Server 28 may be configured to receive multiple auxiliary streams and generate meeting logs that preserve details and facilitate matching of meeting content with attendees. Server 28 may also enable, for select users, multi-faceted reviewing and interaction of meeting notes.

As shown in FIG. 2, server 28 may include a communication interface 50, a processor 31, and a memory 32 having one or more programs 34 and/or data 36 stored thereon. In some embodiments, server 28 may have different modules co-located within a single device, such as within an integrated circuit (IC) chip (e.g., implemented as an application-specific integrated circuit (ASIC) or a field-programmable gate array (FPGA)), or within separate devices having dedicated functions. Some or all of the components of server 28 may be co-located in a cloud, provided in a single location (such as inside a mobile device), or provided in distributed locations.

Communication interface 50 may be configured to send information to and receive information from other components of system 10 via network 30. In some embodiments, Communication interface 50 can include an integrated services digital network (ISDN) card, cable modem, satellite modem, or a modem to provide a data communication connection. As another example, communication interface 50 can include a local area network (LAN) card to provide a data communication connection to a compatible LAN. Wireless links can also be implemented by communication interface 50. In such an implementation, communication interface 50 can send and receive electrical, electromagnetic or optical signals that carry digital data streams representing various types of information via network 30.

Processor 31 can include one or more processing devices configured to perform functions of the disclosed methods. Processor 31 may include any appropriate type of general-purpose or special-purpose microprocessor, digital signal processor, graphic processor, or microcontroller. In some embodiments, processor 31 can constitute a single core or multiple cores executing parallel processes simultaneously. For example, processor 31 can be a single-core processor configured with virtual processing technologies. In certain embodiments, processor 31 uses logical processors to simultaneously execute and control multiple processes. Processor 31 can implement virtual machine technologies, or other known technologies to provide the ability to execute, control, run, manipulate, and store multiple software processes, applications, programs, etc. In another embodiment, processor 31 includes a multiple-core processor arrangement (e.g., dual core, quad core, etc.) configured to provide parallel processing functionalities that allow server 28 to execute multiple processes simultaneously. As discussed in further detail below, processor 31 may be specially configured with one or more applications and/or algorithms for performing method steps and functions of the disclosed embodiments. For example, processor 31 can be configured with hardware and/or software components that enable processor 31 to receive real-time camera feed, receive real-time audio feed, record video, record audio, receive user-provided control instructions regarding video and/or audio playback, and selectively transmit to network 30 the real-time camera feed, the real-time audio feed, the recorded video, the recorded audio, and other associated data streams based on the control instructions. It is appreciated that other types of processor arrangements could be implemented that provide for the capabilities disclosed herein.

Memory 32 may include a volatile or non-volatile, magnetic, semiconductor, tape, optical, removable, non-removable, or other type of storage device or tangible and/or non-transitory computer-readable medium that stores one or more executable programs 34, such as a meeting logging and reviewing app 38 and an operating system 40. Programs 34 may also include communication software that, when executed by processor 31, provides communications with network 30 (referring to FIG. 1), such as Web browser software, tablet or smart handheld device networking software, etc.

Meeting logging and reviewing app 38 may cause processor 31 to perform processes related to generating, transmitting, storing, receiving, indexing, and/or displaying audio and video in association with attendees and other users of a meeting. For example, meeting logging and reviewing app 38 may be able to configure portal 16 to perform operations including: capturing a real-time (e.g., live) video stream, capturing a real-time (e.g., live) voice stream, authenticating an authorized user, displaying a graphical user interface (GUI) for receiving control instructions, receiving control instructions from the authenticated user (e.g., via associated I/O devices and/or a virtual user interface—not shown), processing the control instructions, sending the real-time video and/or audio based on the control instructions, receiving real-time video and/or audio from other portals 16, and playing back selected streams of the video and audio in a manner customized by the user.

Consistent with the present disclosure, meeting logging and reviewing app 38 may cause processor 31 to create user information data and store it in database 26. In some embodiments, meeting logging and reviewing app 38 may cause processor 31 to extract user information from the various data received from communication interface 50, including, e.g., the video streams, audio streams, smart card reading information and/or fingerprinting information provided by the attendees, calendar and email information obtained for users invited to the meeting, and etc. Meeting logging and reviewing app 38 may cause processor 31 to extract user information such as the user's name, contact information, facial features, voice features, biometrics, and etc. from the data received. Meeting logging and reviewing app 38 may further cause processor 31 to match a user's information obtained from multiple sources and construct a bio information data entry for each user. Processor 31 may store the bio information data entry in database 26.

Operating system 40 may perform known functions when executed by processor 31. By way of example, operating system 40 may include Microsoft Windows™, Unix™, Linux™, Apple™ operating systems, Personal Digital Assistant (PDA) type operating systems such as Microsoft CE™ and Android™, or another type of operating system.

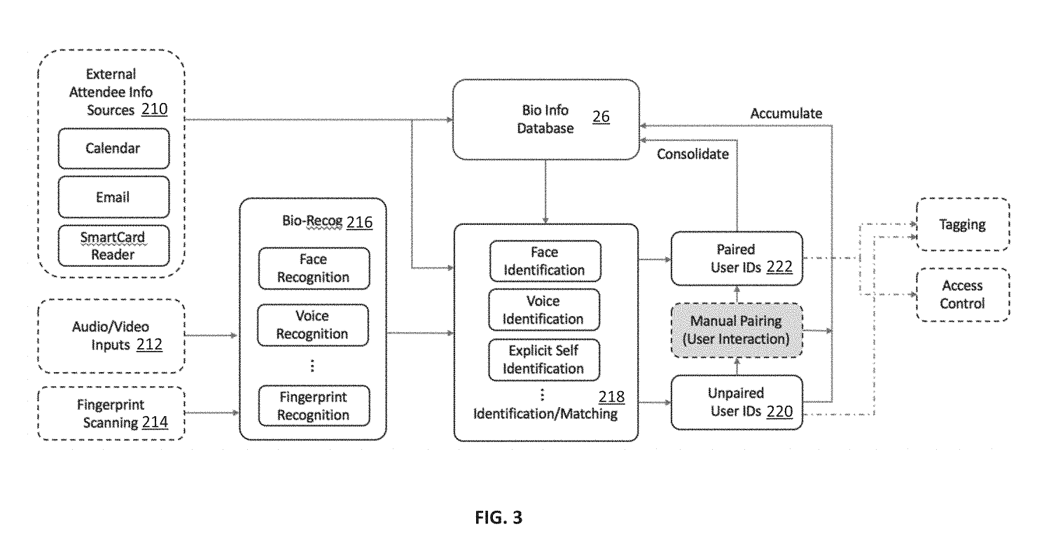

FIG. 3 illustrates an exemplary work flow for constructing a database 26 with bio info entries according to the present disclosure. As shown in FIG. 3, information regarding possible attendees may be collected from various sources, including external attendee info sources 210, audio/video sources 212, and fingerprinting scanner 214, etc. In some embodiments, potential attendees may receive meeting requests via a calendar system and/or over email (e.g., using Microsoft Outlook® or the like). In such embodiments, server 28 may obtain a list of potential attendees in advance of the meeting. Additionally, external attendee info sources 210 also includes a SmartCard Reader that is configured to receive attendee information when the attendee scans the SmartCard to enter the meeting room.

Audio/video sources 212 may be provided by one or more audio/video capture devices such as camera devices 22 and microphone devices 24. When the scheduled meeting is held, one or more audio/video capture devices may be activated (e.g., automatically or by an attendee) and capture video and audio including faces and voices of the attendees. For example, a camera-array that can capture 360-degree surrounding video may be used to capture faces of attendees in a conference room. Similarly, a microphone array may be used capture voices of attendees in the conference room. Additionally or alternatively, extant audio/video capture devices (e.g., one or more mobile phones) may be used to capture faces and/or voices of attendees.

Fingerprinting scanner 214 may collect attendee's fingerprinting information as they enter the meeting room. The attendee may be instructed to place one or more of his fingers on fingerprinting scanner 214. Fingerprinting scanner 214 scans the fingerprints, and provide the information to server 28. In some embodiments, the data provided from audio/video sources 212 and fingerprint scanner 214 may be referred to as biological intrinsic identification data (BIID). Data obtained from external attendee info sources 210 may be referred to as extrinsic identification data (EID).

Consistent with the present disclosure, server 28 may use the captured audio/video information to perform user identification association (e.g., pairing) using an indexed database constructed over time. In some embodiments, server 28 may use a bio-recognition module 216 that includes, e.g., a face recognition module, a voice recognition module, and a fingerprint recognition module. For example, the video may be fed into the facial recognition module. Similarly, the audio may be fed into the voice recognition module. In addition, fingerprint information may be fed into the fingerprint recognition module.

In some embodiments, the recognition modules may be pre-trained to recognize features from the data and provide the features to identification/matching modules 218 to associate the features with a certain user. Identification/matching modules 218 may include, e.g., a face identification module, a voice identification module, and an explicit self-identification module. For example, server 28 may extract facial and vocal features about the attendees, which may be fed into the facial and voice identification modules. In some embodiments, voiceprint may be used for the vocal identification process. Sometimes, an attendee may explicitly identify himself, e.g., through self-introduction. The self-identification information may be extracted from a transcribed text of the audio signal.

In some embodiments, identification/matching modules 218 may match incoming features against all previously collated bio-features (that is, BIID features). To improve the efficiency of this matching, sever 28 may use the EID information to extract corresponding BIID features (in embodiments where an association between EID and BIID already exists) and match incoming A/V-captured biological features against the smaller batch of extracted BIID features. For embodiments with unmatched BIID features, server 28 may optionally compare the features against the whole database.

In some embodiments, server 28 may use deep learning technology (such as a recurrent neural network with long short-term memory architecture, also termed RNN-LSTM) or use online cloud-based automatic speech recognition services to transcribe speech from a participant and extract mentions of the participants' names. Similarly, server 28 may perform gesture and action (e.g., pointing, nodding, speaking, smiling) detection on the incoming video stream using one or more deep learning technologies, e.g., a convolutional neural network. In one example, server 28 may use the time when a name is mention and when a reaction occurs and apply a simple rule to pair these partial pieces of identification information. Accordingly, server 28 may leverage the temporal proximity as a primary filter such that association between voice and facial features may be performed using the temporal coincidence of the sound signal and the speaking action. In another example, server 28 may map a name ID to voice features (e.g., spoken in self-introduction) and/or facial features (e.g., in responding to an introduction by others) based on speech content understanding. For embodiments with transitive BIID features, server 28 may still pair up the EIDs and corresponding BIIDs.

For records with already-paired EIDs and BIIDs 222, server 28 may extract the BIID features from the record and update the database accordingly. For records with newly-paired EIDs and BIIDs, the newer record may be merged with other, separate EID and BIID records that match into one record via consolidation. Outstanding (i.e., unpaired or orphan) EIDs and BIIDs may be stored as separate, partial, records in database 26. This is referred to as a database accumulation process. In some embodiments, server 28 may assign a temporary unique ID (e.g., user Johnson) to a new partial record and use this temporary ID to tag received audio/video segments (or perform other activities that require an ID tag to be leveraged). For unpaired BIIDs 220, server 28 may keep a photo, a short audio clip and/or a short video clip, which may be used in manual association processes.

After the meeting, server 28 may prompt a reviewer of the meeting logs and/or notes to assist with association of outstanding EIDs and BIIDs by providing the list to the reviewer and asking the reviewer to connect corresponding items. For unpaired BIIDs 220, the reviewer may also directly input EID information, whether partial or complete. Such information may then be used to complete consolidation of database 26 and update the tagged streams accordingly. Additionally or alternatively, user input may be opportunistically sought during later log reviewing. In some embodiments, users may request correction if they notice an incorrect association between EIDs and BIIDs, e.g., tags having the wrong person name.

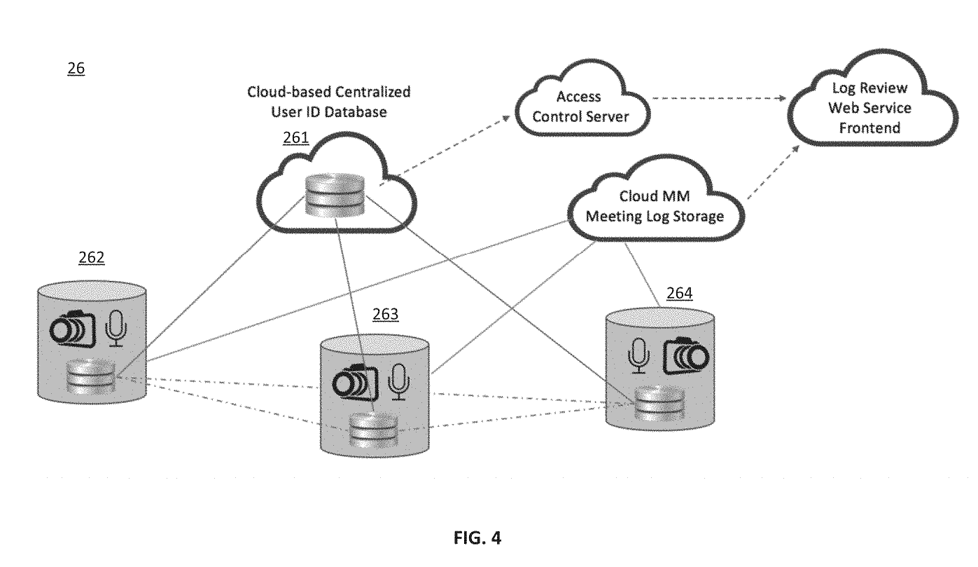

FIG. 4 illustrates two exemplary configurations of system 10. In one configuration, a cloud-based centralized user ID database 261 may be maintained in the cloud. In some embodiments, cloud-based centralized user ID database 261 may include a cloud-based multi-modality meeting log storage that stores all the audio/video meeting records and/or auxiliary streams. Each meeting log system, e.g., equipped at different meeting rooms, may maintain a local cache of a user ID database (e.g., 262-264). As shown in FIG. 4, the local system may request BIID information from the centralized system using known EIDs obtained from a meeting schedule. Central database 261 may reply. After executing an automatic EID-BIID pairing process according to the present disclosure, the user ID cache of the local system may be updated and synced with the centralized database. In some embodiments, local meeting log system may clear its cache when the logs are processed after the meeting. In some embodiments having multiple meeting log system, for each unpaired BIID, the auto assigned temporary ID may be prefixed with (or otherwise include) the meeting ID, which may be a unique GUID for a meeting. Accordingly, the temporary ID may be of the form [meeting-GUID::user Johnson] when synced back to central database 261. The access control server may relay to the centralized user ID database 261 for proper access right assessment. The cloud maintaining centralized database 261 may be a public cloud service (such as Amazon AWS, Microsoft Azure, etc.), or a private cloud.

In an alternative configuration (depicted using dash-dotted lines in FIG. 4), system 10 may operate in a distributed fashion and adopt distributed file storage and synchronization protocols. For example, the system may adopt a Distributed Hash Table (DHT) based peer-to-peer storage. In this configuration, the local database and audio/video content may be stored locally, with each DHT node maintaining pointers to all audio/video content and meeting logs on other nodes and with the user ID database being synced, merged and fully replicated across all nodes. In this configuration, the meeting log material may be streamed from the node hosting the information to a reviewing client.

Successful and accurate association of EIDs and BIIDs, in addition to the aforementioned application of tagging meeting participants, may also be leveraged to facilitate access control for the dissemination of meeting logs/notes, via an email system, via a web service, or the like. By default, meeting participants may be granted access. Once a user accesses a shared link of the meeting log, her IDs may be checked against the ID information (either locally carried in the log or stored on a dedicated access control server that maintains the access list of meetings under its management), and the access may then be granted or denied accordingly. Access control may be performed on a per-meeting basis. In business applications, access control may be performed according to privilege management. For example, a meeting owner/organizer may assign a privilege level to the meeting, which automatically grants access right according to the specific assigned privilege policy. Accordingly, access control implemented according to the present disclosure may help implement privilege management for a business.

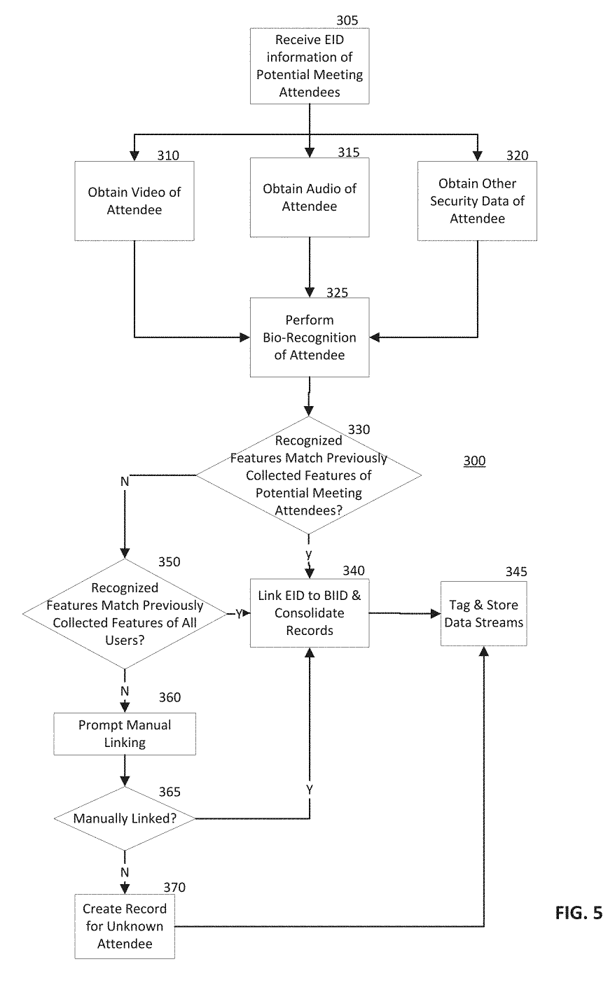

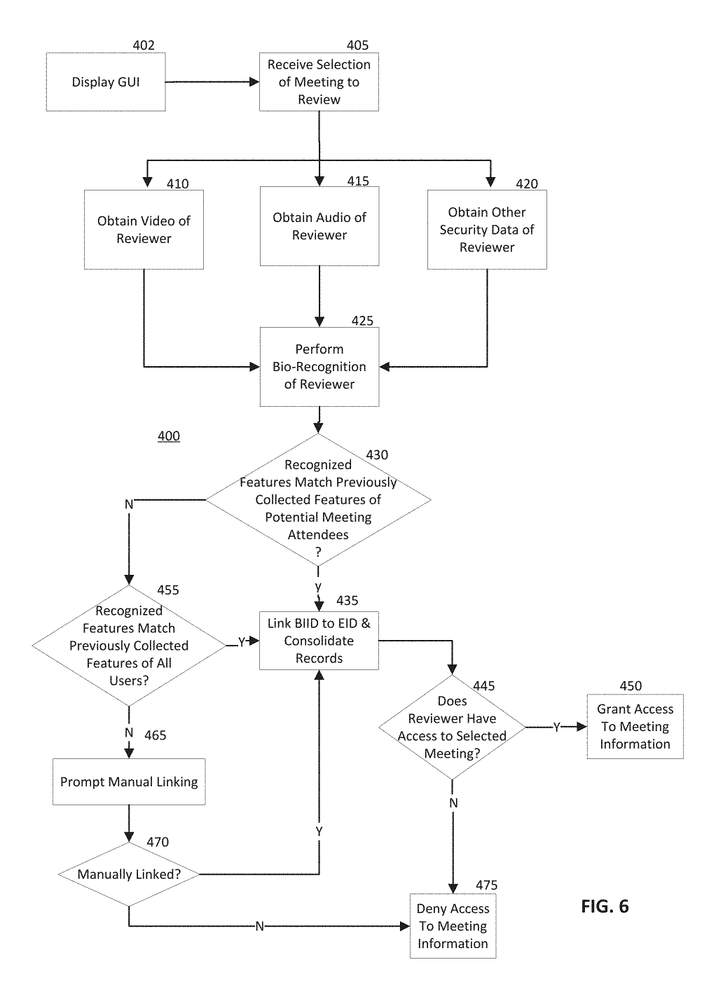

FIGS. 5 and 6 illustrate flowcharts of exemplary methods 300 and 400, respectively, for logging and reviewing meeting-related data. Methods 300 and/or 400 can be performed by the various devices disclosed above. For example, in some embodiments, methods 300 and/or 400 are performed by server 28 (e.g., by processor 31 of server 28).

Method 300 may be implemented in real-time throughout a meeting. Method 300 may begin with receipt of EID associated with individuals having the potential to attend a particular meeting (Step 305). These potential attendees may include, for example, individuals to whom an invitation for the meeting was sent, individuals who accepted the invitation, individuals having the meeting scheduled on their calendar, individuals copied on or referenced within an email pertaining to the meeting, individuals having authorization to attend any meeting of a particular security level (e.g., CEO of the company), etc. This list of individuals may be automatically generated by server 28 for every meeting or alternatively provided to server 28 by another component (e.g., by portal 16, an associated calendaring module, an associated email module, etc.) or user (e.g., a meeting organizer) of system 10. The EID may include, among other things, a name of the potential attendee, an email address, a phone number, an employer identifier, an employment location identifier, a position or security clearance, etc.

Method 300 may then continue with server 28 obtaining BIID for each attendee of the meeting. For example, video (Step 310), audio (Step 315), and/or other security data (Step 320) related to the unique biology of each attendee of the meeting may be obtained by server 28. The video may be associated with the body and/or face of the attendee, while the audio may be associated with the voice of the attendee. The other security data may include, for example, an iris scan, a fingerprint scan, or a scan of a badge that includes a photo of the attendee. The BIID may be captured via portal 16 (e.g., via camera device 22 and microphone device 24—referring to FIG. 1) and/or via security device 42, and transmitted to server 28 via network 30. It should be noted that Steps 310-320 may be completed at the same time or in any order. It is also contemplated that fewer than all (e.g., only one or two) of Steps 310-320 may be completed, in some embodiments.

It should be noted that, during the completion of Step 320, some EID may be obtained simultaneously with the BIID. For example, a badge that includes the photo of the attendee may also include a chip having stored thereon some or all of the EID of the attendee. In this example, the scan of Step 320 may also result in the obtaining of the EID for the attendee, as well as automatic linking of the EID to the BIID.

Following Step 320, server 28 may perform bio-recognition of the obtained BIID (Step 325). For example, body, facial, retinal, and/or fingerprint characteristics may be recognized based on the video and/or the other security data; and/or vocal characteristics may be recognized based on the audio. Bio-recognition may be performed using, for example, an online (e.g., cloud-based) artificial intelligence service, an on-device deep-learning method, offline software development kits, or another similar technology. Via these technologies (and/or others), a library of identifying bio-characteristics may be generated for each attendee in the meeting. These characteristics can be expressed digitally, visually, and/or mathematically (e.g., as formulas).

The characteristics recognized at Step 325 (i.e., the BIID of each attendee) may then be compared to corresponding known characteristics (i.e., BIIDs stored within database 26) of the potential meeting attendees (Step 330). When this comparison of characteristics of each particular attendee with known characteristics of the potential attendees results in a high-confidence match (e.g., a match having a confidence level greater than a threshold), the EID and BIID of the matched attendee may be linked together and the corresponding records consolidated within database 26 (Step 340). In particular, in some situations, the existing records for the attendee may not include all of the BIID and/or EID collected during completion of Steps 310-320. In these situations, the newly captured and recognized BIID and/or EID may be stored in the attendee record within database 26. It is also contemplated that, when the BIID and/or EID collected at Steps 310-320 is different from what is stored in the attendee records (i.e., not necessarily missing), the attendee records may be updated to include the latest and newest information. The attendee record stored within database 26 may have the following format:
[attendee name, email1, email2, phone number, company ID, employee ID, facial features, vocal features, fingerprint features, iris features, etc.]

After successful completion of Steps 330 and 340, server 28 may electronically tag the various data streams generated during the meeting with the attendee's corresponding EID (Step 345), and store the tagged data streams within database 27 for later retrieval and review by an authorized user (e.g., when the user selects the tagging as a data stream search filter).

Returning to Step 330, when the match does not have a high enough confidence level, server 28 may attempt to match the characteristics recognized at Step 325 to corresponding known characteristics of all users (i.e., not just users who are potential attendees of the meeting) that are stored within database 26 (Step 350). When this comparison results in a high-confidence match, control may proceed to Step 340 described above.

It should be noted that Step 330 could be replaced with Step 350, if desired. Specifically, rather than first attempting to match the recognized characteristics with a smaller set of characteristics corresponding to only potential attendees, server 28 could immediately attempt to match the recognized characteristics with characteristics of all known users. While simpler, doing so could result in longer match-times under some conditions.

If, during completion of Step 350, server 28 is still unable to match the recognized characteristics with the known characteristics found within any user records stored in database 26, server 28 may generate a prompt for manual linking of the BIID to the EID (Step 360). For example, the recognized characteristics (or alternatively the video and/or audio of the associated attendee) may be provided to a user (e.g., during and/or after the meeting via portal 16) for use in manually linking the BIID to the EID of the attendee. The user may be another attendee of the same meeting who may personally know the unidentified attendee, the meeting organizer, a reviewer of the meeting (e.g., during review of meeting notes), or another individual (e.g., a manager responsible for the attendees and/or the meeting).

It may also be possible, in some situations, for server 28 to link the BIID with the EID of a particular attendee based on content from the meeting. For example, a meeting organizer (or other participant) may introduce attendees at a start of the meeting or otherwise refer to or address a particular attendee by name during the meeting. In this example, server 28 may be configured to detect usage of the attendee's name (e.g., via speech recognition) and also to detect the attendee being referred to or addressed. Detection of the attendee being referred to or addressed may be made based on a detected gesture of the meeting organizer (e.g., when the meeting organizer points to the attendee) or another meeting participant, for example using one or more deep learning technologies (e.g., a convolutional neural network or a recurrent neural network with long short-term memory architecture). Specifically, server 28 may use a time when the attendee's name is mentioned and a reaction occurs, and apply a simple rule to pair these sources of information to a known location and/or a response (e.g., a vocal response) of the attendee. Server 28 may then leverage a temporal proximity of the attendee as a filter, such that an association between the recognized characteristics (e.g., voice and/or facial features) and the mentioned name can be made. Server 28 may thereafter link the BIID with the appropriate EID of the attendee (Step 340).

In some situations, the BIID of a particular attendee may not be successfully linked to any EID stored within database 26 (Step 365). In this situation, server 28 may create a new record for the attendee that includes only the BIID (Step 370). This record may be assigned a temporary and unique identifier for the attendee that can then be used to tag any associated data streams generated during the meeting and stored within database 27 at Step 345.

Method 400 (referring to FIG. 6) may be implemented during and/or after conclusion of a meeting. Method 400 may begin with the showing of a graphical user interface (GUI) on display 25 (referring to FIG. 1) (Step 402). The user may be able to provide input selections and/or meeting parameters via the GUI. These meeting parameters may include, for example, a date, a time, and/or a title of a particular meeting that the user wishes to review. The meeting parameters may be received via portal 16, and used to retrieve one or more compressed files stored in database 27 that correspond with the particular meeting (Step 405).

As described above, some meetings may be of a confidential nature. In this situation, only select users may be granted access to particular meeting files. Accordingly, at some point near the beginning of method 400 (e.g., before, during, and/or after completion of Steps 402 and 405), server 28 may obtain video, audio, and/or other security data (e.g., via portal 16 and/or security device 42) associated with the user (Steps 410, 415, and 420, respectively). Server 28 may then perform bio-recognition on the data, in association with the user (Step 425), and attempt to match recognized characteristics with previously collected characteristics of meeting attendees (Step 430). When the match has a high-level of confidence, the BIID of the user may be linked to the EID of the user, and the associated record stored within database 26 may be consolidated (Step 435). Steps 410-435 may be similar to Steps 310-335 described above.

After successful completion of Step 435, server 28 may determine if the identified user has the appropriate security clearance to access the selected meeting files (Step 445). In some embodiments, as long as the user was an original attendee of the meeting, the user may be granted access to the meeting files (Step 450). However, in other situations, only a subset of the original attendees may be granted access. In these situations, server 28 may compare the EID of the user to the EIDs of attendees having authorization to access the meeting files, and only grant access to the user upon success in the comparison. When the user is not authorized to access the selected meeting files, server 28 may deny access of the meeting files to the user (Step 475).

Returning to Step 430, when the match does not have a high enough confidence level, server 28 may attempt to match the characteristics recognized at Step 425 to corresponding known characteristics of all users (i.e., not just the known attendees of the meeting) that are stored within database 26 (Step 455). When this comparison results in a high-confidence match, control may proceed to Step 435 described above. It should be noted that Step 430 could be replaced with Step 455, if desired. Specifically, rather than first attempting to match the recognized characteristics of the user with a smaller set of characteristics corresponding to only known attendees of the meeting, server 28 could immediately attempt to match the recognized characteristics with characteristics of all known and/or authorized users. While simpler, doing so could result in longer match-times under some conditions.

If, during completion of Step 455, server 28 is still unable to match the recognized characteristics with the known characteristics found within any user records stored in database 26, server 28 may generate a prompt for manual linking of the BIID of the user to a known EID (Step 465). For example, the recognized characteristics (or alternatively the video and/or audio of the associated attendee) may be provided (e.g., in real time) to a security administrator for use in manually linking the BIID to the EID of the user. Upon successful manual linking (Step 470), control may proceed to Step 435 described above. Otherwise, control may proceed to Step 475.

When access to the files of a particular meeting has been granted to an identified and authorized user, the associated compressed files may then be separated into different data streams. Additional options may then become available for selection by the user via the GUI. For example, the topic list, the index, a list of meeting attendees (e.g., the tagging of identification information associated with each attendee), a list of displays 25 used during the meeting, and/or various time-related options may be shown on display 25.

A selection from the user may then be received, including search criteria associated with the different data streams and options discussed above. For example, the user may be able to pick a particular topic to follow, input one or more key words, identify an attendee of the meeting (e.g., associated with the tagging described above), choose a particular display 25 to view, and/or select a time period within the meeting. Based on these selections, any number of different searches and/or filters of the separated data streams may then be applied. Once all of the user selections have been made and the corresponding audio, video, and/or transcript returned, the meeting data may be played back on display 25 of portal 16.

The disclosed system and methods may improve security and access-efficiencies associated with logging and reviewing meeting content. For example, manual authentication of attendees and/or content reviewers may no longer be required and, thus, the errors and deficiencies normally associated with the manual process may be avoided. This may also facilitate greater sharing of meeting content among authorized users, as well as greater consumption of the content at a higher level.

Another aspect of the disclosure is directed to a non-transitory computer-readable medium that stores instructions, which, when executed, cause one or more of the disclosed processors (e.g., processor 31 of server 28) to perform the methods discussed above. The computer-readable medium may include volatile or non-volatile, magnetic, semiconductor, tape, optical, removable, non-removable, or other types of computer-readable medium or computer-readable storage devices. For example, the computer-readable medium may be memory 32 and the computer instructions stored thereon may include programs 34 (e.g., meeting logging and reviewing app 38, operating system 40, etc.) and/or data 36.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. A system for managing an access control of a meeting, comprising:
a communication interface configured to receive video of the meeting captured by at least one camera device and audio of the meeting captured by at least one microphone device;
a memory having computer-executable instructions stored thereon; and
a processor in communication with the communication interface and the memory, the processor being configured to execute the computer-executable instructions to:
generate a biometric characteristic for an attendee of the meeting based on at least one of the video and the audio;
selectively associate identity information of the attendee with the biometric characteristic based on a comparison of the biometric characteristic with stored biometric characteristics of known users;
generate a data stream that includes at least one of the video and the audio of the attendee;
tag the data stream with the identity information of the attendee based on the associated biometric characteristic; and
selectively cause the data stream to be shown on a display based on selection of the tag.

2. The system of claim 1, wherein the biometric characteristic includes at least one of a facial characteristic, a voice characteristic, an iris characteristic, and a fingerprint characteristic.

3. The system of claim 1, wherein the known users include potential attendees of the meeting.

4. The system of claim 3, wherein the processor is further configured to determine the potential attendees of the meeting based on at least one of a meeting invitation, calendar information, and emails.

5. The system of claim 1, wherein the processor is further configured to add the generated biometric characteristic associated with a user to the stored biometric characteristics of the known user.

6. The system of claim 1, wherein, when the comparison indicates a low-confidence match between the biometric characteristic of the attendee and the stored biometric characteristics, the processor is further configured to generate a prompt for manual linking of the identity information of the attendee to the biometric characteristic of the attendee.

7. The system of claim 6, wherein when the manual linking is unsuccessful, the processor is further configured to assign temporary identification information to the biometric characteristic of the attendee.

8. The system of claim 1, wherein:
the communication interface is further configured to receive additional security data associated with the attendee from a security device; and
the processor is in further communication with the security device and configured to generate the biometric characteristic for the attendee of the meeting based on at least one of the video, the audio, and the additional security data.

9. The system of claim 1, wherein:
the communication interface is further configured to receive at least one of video of a user captured after the meeting by the at least one camera device and audio of the user captured after the meeting by the at least one microphone device; and
the processor is further configured to:
receive from the user a request to access a log of the meeting;
generate a biometric characteristic for the user based on at least one of the video and the audio of the user;
associate identity information of the user with the biometric characteristic for the user based on a comparison of the biometric characteristic for the user with stored biometric characteristics of known users; and
selectively cause the log of the meeting to be shown on the display based on the identity information of the user.

10. The system of claim 1, wherein the identity information of the attendee includes at least one of a name, a phone number, an email address, and employer identifier, and an employment location identifier.

11. A method of managing an access control of a meeting, comprising:
receiving, by a communication interface, at least one of video of the meeting captured by at least one camera device and audio of the meeting captured by at least one microphone device;
generating, by a processor, a biometric characteristic for an attendee of the meeting based on at least one of the video and the audio;
associating, by the processor, identity information of the attendee with the biometric characteristic based on a comparison of the biometric characteristic with stored biometric characteristics of known users;
generating, by the processor, a data stream that includes at least one of the video and the audio of the attendee;
tagging, by the processor, the data stream with the identity information of the attendee based on the associated biometric characteristic; and
selectively causing, by the processor, the data stream to be shown on a display based on selection of the tagging.

12. The method of claim 11, wherein the biometric characteristic includes at least one of a facial characteristic, a voice characteristic, an iris characteristic, and a fingerprint characteristic.

13. The method of claim 11, wherein the known users include potential attendees of the meeting.

14. The method of claim 13, further including determining, by the processor, the potential attendees of the meeting based on at least one of a meeting invitation, calendar information, and emails.

15. The method of claim 11, further including adding, by the processor, the generated biometric characteristics associated with a user to the stored biometric characteristics of the known user.

16. The method of claim 11, wherein, when the comparison indicates a low-confidence match between the biometric characteristic of the attendee and the stored biometric characteristics, the method further includes generating a prompt, by the processor, for manual linking of the identity information of the attendee to the biometric characteristic of the attendee.

17. The method of claim 16, wherein when the manual linking is unsuccessful, the method further including assigning, by the processor, temporary identification information to the biometric characteristic of the attendee.

18. The method of claim 11, further including receiving, by the communication interface, additional security data associated with the attendee from a security device, wherein generating the biometric characteristic for the attendee includes generating the biometric characteristic for the attendee of the meeting based on at least one of the video, the audio, and the additional security data.

19. The method of claim 11, further including:
receiving, by the communication interface, at least one of video of a user captured after the meeting by the at least one camera device and audio of the user captured after the meeting by the at least one microphone device;
receiving, by the processor, a request from a user to access a log of the meeting;
generating, by the processor, a biometric characteristic for the user based on at least one of the video and the audio of the user;
associating, by the processor, identity information of the user with the biometric characteristic for the user based on a comparison of the biometric characteristic for the user with stored biometric characteristics of known users; and
selectively causing, by the processor, the log of the meeting to be shown on the display based on the identity information of the user.

20. A non-transitory computer-readable medium storing instructions that are executable by at least one processor to cause performance of a method for managing an access control of a meeting, the method comprising:
receiving at least one of video of the meeting captured by at least one camera device and audio of the meeting captured by at least one microphone device;
generating a biometric characteristic for an attendee of the meeting based on at least one of the video and the audio;
associating identity information of the attendee with the biometric characteristic based on a comparison of the biometric characteristic with stored biometric characteristics of known users;
generating a data stream that includes at least one of the video and the audio of the attendee;
tagging the data stream with the identity information of the attendee based on the associated biometric characteristic; and
selectively causing the data stream to be shown on a display based on selection of the tagging.
